(19) United States
(12) Patent Application Publication
(10) Pub. No.: US 2009/0003184 A1
(43) Pub. Date: Jan. 1, 2009

(54) Method of Moving Tracks, Method and Apparatus of Recording and/or Playback

(76) Inventors: Jeong Kyo Seo, Gyeonggi-do (KR); Jin A Kim, Gyeonggi-do (KR)

Correspondence Address: HARNESS, DICKEY & PIERCE, P.L.C., P.O. BOX 8910, RESTON, VA, 20195, US

(21) Appl. No.: 12/224,211

(22) PCT Filed: Mar. 20, 2007
(86) PCT No.: PCT/KR2007/001355

§ 371 Date: Aug. 21, 2008

(30) Foreign Application Priority Data
Mar. 23, 2006 (KR) 10-2006-0026633
Aug. 8, 2006 (KR) 10-2006-0074637
Jan. 23, 2007 (KR) 10-2007-0007233

(51) Int. Cl. G11B 7/00

(52) U.S. Cl. 369/112.23; G9B/7

(57) ABSTRACT

A recording and/or playback apparatus and method and a method of moving tracks, and more particularly, an apparatus and method for efficiently seeking a track and recording and/or playback data on/from a recording medium, are disclosed. The method of moving tracks includes changing a gap between a lens part and a recording medium in correspondence with a distance of moving tracks when the lens moves from a current track to another track. Accordingly, it is possible to minimize or prevent the collision between the lens part and the recording medium and to efficiently seek the track to perform recording/reproduction when recording and/or playback data on/from the recording medium.

### TECHNICAL FIELD

The present invention relates to a method of moving tracks and method and apparatus of recording and/or playback, more particularly, to an apparatus and method for efficiently moving tracks and recording and/or playback data on/from a recording medium.

### BACKGROUND ART

Generally, an optical recording and/or playback apparatus records/reproduces data on/from a disc such as a compact disc (CD) or a digital versatile disc (DVD). As the preferences of consumers have changed, a technology for processing a high-definition moving image is required. In addition, as a moving-image compression technology has been developed, a high-density recording medium is required. A technology related to an optical head, that is, an optical pickup, is necessary for developing the high-density recording medium.

The recording density of the recording medium depends on the diameter of a light beam irradiated onto a recording layer of the recording medium. That is, as the diameter of the focused light beam irradiated onto the recording medium is small, the recording density increases. The diameter of the focused light beam is determined by two factors including numerical aperture (NA) of a lens used in focusing and the wavelength of the light beam focused by the lens.

Since the wavelength of the focused light is short, the recording density increases. Accordingly, in order to increase the recording density of the recording medium, a light beam having a short wavelength is used. That is, a blue light beam can increase the recording density more than a red light beam. However, since a far field recording head using a general lens has a light diffraction limitation, there is a limitation to reduce the diameter of the light beam. Accordingly, a near field recording (NFR) apparatus capable of storing and reading information in a unit smaller than the wavelength of the light beam based on near field optics is being developed.

A near field optical recording apparatus using a near field lens can obtain a light beam having a light diffraction limitation or less using the near field lens having a refractive index higher than that of an objective lens, and the light beam propagates to the recording medium close to an interface in a form of an evanescent wave to store high-density bit information. For convenience of description, an area for forming the evanescent wave is called a near field.

However, the conventional apparatus has the following problems.

That is, in order to maintain the evanescent wave, the lens must be maintained so as to be close to the recording medium. Accordingly, in consideration of axial vibration of the recording medium or a tilt at the time of the drive of a pickup, it is difficult to prevent the recording medium from colliding with the bottom surface of the near field lens.

In particular, in order to seek a desired point of the recording medium, while lens part moves the tracks by moving the light beam generated at the optical pickup from a current track to a target track, a probability of collision increases.

### DISCLOSURE OF INVENTION

Accordingly, the present invention is directed to a recording and/or playback apparatus and method and a method of moving tracks that substantially obviate one or more problems due to limitations and disadvantages of the related art.

An object of the present invention devised to solve the problem lies on an efficient method of moving tracks and a recording and/or playback method apparatus using the same.

Another object of the present invention devised to solve the problem lies on a method of moving tracks capable of minimizing an error due to collision while lens part moves the tracks, and a recording and/or playback method and apparatus using the same.

The object of the present invention can be achieved by providing a method of moving tracks comprising: changing a gap between a lens part and a recording medium in correspondence with a distance of moving tracks when the lens moves from a current track to another track. The gap between the lens and the recording medium may be stepwise changed according to the distance of moving tracks.

In another aspect of the present invention, provided herein is a recording and/or playback method comprising: controlling a gap between a lens and a recording medium to be uniform, using a control signal, wherein the gap between the lens and the recording medium is changed by applying an offset corresponding to a distance of moving tracks to the control signal while lens part moves the tracks. The offset may be stepwise changed in correspondence with the distance of moving tracks, and the level of the offset may be proportional to the distance of moving tracks.

In another aspect of the present invention, provided herein is a method of recording and/or playback data on/from a recording medium, comprising: (a) receiving a track seek command from a current track to another track of the recording medium, (b) changing a gap between a lens and the recording medium to a first level and moving the lens or an optical pickup to a target track in correspondence with the track seek command; (c) changing the gap between the lens and the recording medium to an original state at a reached track and checking the position of the current track; and (d) changing the gap between the lens and the recording medium to a second level and minutely moving the lens or the optical pickup from the reached track to the target track while a track is counted. The first level may be larger than the second level.

In another aspect of the present invention, provided herein is a recording and/or playback apparatus comprising: a pickup irradiating a light beam emitted from a optical source onto a recording medium and including a lens; a gap servo feedback-controlling a gap between the lens and the recording medium using a gap control signal generated by the light beam reflected from the recording medium; and a controller applying an offset corresponding to a distance of moving tracks to the gap control signal, the gap control signal changing the gap between the lens and the recording medium while lens part moves the tracks. The controller may stepwise apply the offset which is changed according to the distance of moving tracks and change the distance according to the distance of moving tracks.

### BRIEF DESCRIPTION OF DRAWINGS

The accompanying drawings, which are included to provide a further understanding of the invention and are incorporated in and constitute a part of this application, illustrate embodiment(s) of the invention and together with the description serve to explain the principle of the invention.

In the drawings:

FIG. 1 is a block diagram showing the configuration of a recording and/or playback apparatus according to an embodiment of the present invention;

FIG. 2 is a block diagram showing the configuration of an optical system of an optical pickup according to the embodiment of the present invention;

FIG. 3 is a schematic side cross-sectional view showing a lens part and a recording medium according to the embodiment of the present invention;

FIG. 4 is a schematic diagram showing the flow of a signal generated in a signal generator according to the embodiment of the present invention;

FIG. 5 is a graph showing a relationship between a gap error signal and a gap between the lens part and the recording medium according to the embodiment of the present invention;

FIG. 6 is a flowchart illustrating a method of controlling the gap between the lens part and the recording medium according to the embodiment of the present invention;

FIG. 7 is a partial schematic cross-sectional view showing a distal end of the lens part and the recording medium according to the embodiment of the present invention;

FIGS. 8a and 8b are a table and a graph showing a tilt limitation angle and the gap between the lens part and the recording medium, respectively;

FIG. 9 is a graph showing a variation in the gap between the lens part and the recording medium while lens part moves the tracks, according to the present invention;

FIG. 10 is a table showing a variation in the gap between the lens part and the recording medium according to a distance of moving tracks;

FIG. 11 is a graph showing the variation in the gap between the lens part and the recording medium while lens part moves the tracks, according to another embodiment of the present invention;

FIG. 12 is a view showing in detail an internal structure of the controller according to an embodiment of the present invention;

FIG. 13 is a graph showing the variation in the gap between the lens part and the recording medium according to another embodiment of the present invention; and

FIG. 14 is a graph showing the efficient horizontal movement velocity of the lens part according to the embodiment of the present invention.

### BEST MODE FOR CARRYING OUT THE INVENTION

Reference will now be made in detail to the preferred embodiments of an optical pickup and a recording medium according to the present invention, examples of which are illustrated in the accompanying drawings. Hereinafter, a “recording medium” in the present specification includes all media on which data is recorded or will be recorded, such as an optical disc. A “recording and/or playback apparatus” in the present specification includes all apparatuses which are capable of recording and playback data on/from the recording medium. For convenience of description and better understanding of the present invention, a recording and/or playback apparatus using a near field will hereinafter be exemplarily described, but the present invention is not limited to the present embodiment.

In addition, although the terms used in the present invention are selected from generally known and used terms, some of the terms mentioned in the description of the present invention have been selected by the applicant at his or her discretion, the detailed meanings of which are described in relevant parts of the description herein. Furthermore, it is required that the present invention is understood, not simply by the actual terms used but by the meanings of each term lying within

Hereinafter, a recording and/or playback apparatus according to the embodiment of the present invention will be described in detail. Wherever possible, the same reference numbers will be used throughout the drawings to refer to the same or like parts.

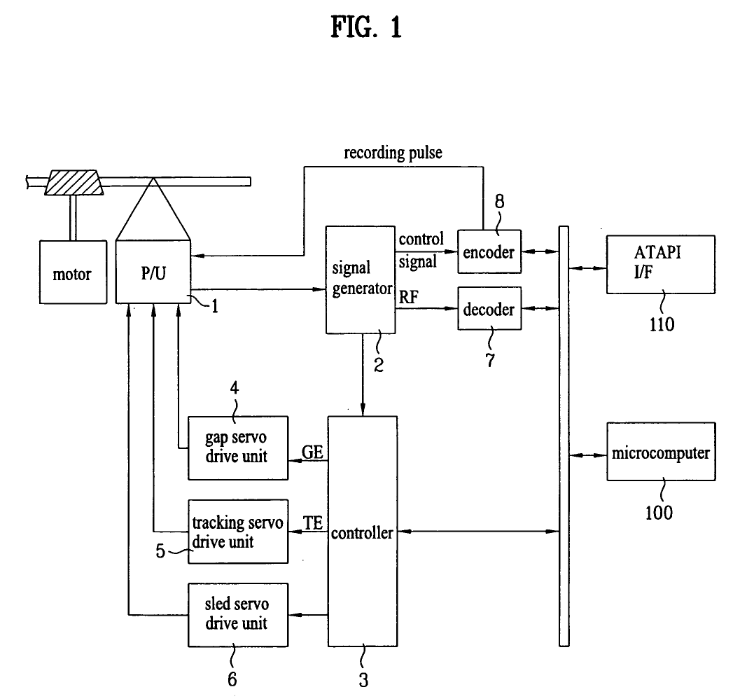

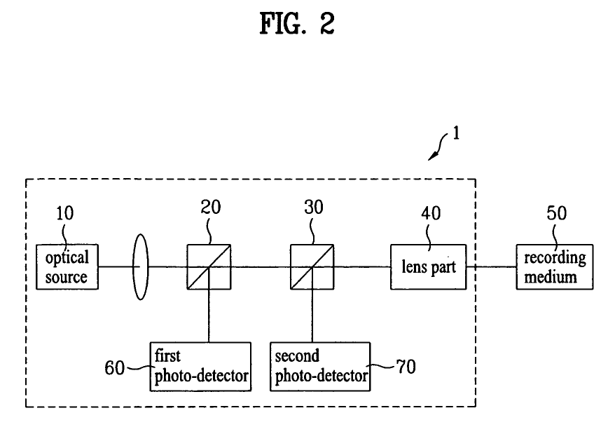

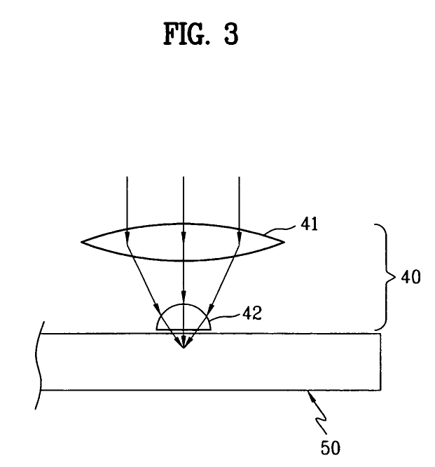

FIG. 1 schematically shows the configuration of a recording and/or playback apparatus according to the embodiment of the present invention. The configuration of the recording and/or playback apparatus will be described in detail with reference to FIGS. 2 and 3.

An optical pickup (P/U) 1 irradiates a light beam onto a recording medium, focuses the light beam reflected from the recording medium, and generates a signal. An optical system (not shown) included in the optical pickup 1 may be configured as shown in FIG. 2. That is, the optical system included in the optical pickup 1 may include a optical source 10, separation/combination parts 20 and 30, a lens part 40 and photo-detectors 60 and 70.

The optical source 10 may use a laser having an excellent rectilinear propagation property. Therefore, the optical source 10 is, for example, a laser diode. The light beam emitted from the optical source 10 and irradiated onto the recording medium may be parallel light beam. A lens such as a collimator for making light beam parallel may be provided on the path of the light beam emitted from the optical source.

The separation/combination parts 20 and 30 separate the light beams, which are input in the same direction, or combine the light beams which are input in different directions. In the present embodiment, the first separation/combination part 20 and the second separation/combination part 30 are included. The first separation/combination part 20 passes a part of the incident light beam and reflects another part of the incident light beam (in the present embodiment, the first separation/combination part 20 is a non-polarized beam splitter (NBS)). The second separation/combination part 30 passes only light beam which is polarized in a specific direction according to a polarization direction (in the present embodiment, the second separation/combination part 30 is a polarized beam splitter (PBS)). When a linearly polarized light beam is, for example, used, the second separation/combination part 30 may pass only a vertically polarized component and reflect a horizontally polarized component. Alternatively, the second separation/combination part 30 may pass only a horizontally polarized component and reflect a vertically polarized component.

The lens part 40 transmits the light beam emitted from the optical source 10 to the recording medium 50. The lens part 40 according to the embodiment of the present invention includes an objective lens 41 and a near field lens 42 provided on a path along which the light beam passing through the objective lens 41 enters the recording medium. That is, by providing the near field lens 42 having a high refractive index in addition to the objective lens 41, the numerical aperture of the lens part 40 increases and thus an evanescent wave is formed. The near field lens 42 may be, for example, a solid immersion lens (SIL) or a hemisphere or super-hemisphere (a portion of a sphere having a height smaller than that of a sphere and larger than that of a hemisphere is called a super-hemisphere) lens formed by cutting a sphere lens.

The optical system of the optical pickup 1 including the lens part 40 is located close to the recording medium 50. That is, the relative positional relationship between the lens part 40 and the recording medium 50 is as follows. When the lens part 40 and the recording medium 50 are close to each other by about ¼ (that is, λ/4) or less of a light wavelength, a part of the light beam which enters the lens part 40 at a threshold angle or more forms the evanescent wave, which passes through the recording medium 50 to reach a recording layer, without totally reflecting from the surface of the recording medium 50. The evanescent wave which reaches the recording layer may be used for recording/reproduction. However, when the gap between the lens part 40 and the recording medium 50 increases to λ/4 or more, the light wavelength loses evanescent wave properties and returns to an original wavelength, which totally reflects from the surface of the recording medium 50. Therefore, in the recording and/or playback apparatus using the near field, the gap between the lens part 40 and the recording medium 50 is maintained at about λ/4 or less. Here, λ/4 is a near field limitation.

The photo-detectors 60 and 70 receive the reflected light beams and transform the received light beams into electric signals. In the present embodiment, the first photo-detector 60 and the second photo-detector 70 are included. The first photo-detector 60 or the second photo-detector 70 may include two photodetectors PDA and PDB which are halved in a radial direction or a signal track direction of the recording medium 50. The photodetectors PDA and PDB generate electric signals A and B proportional to the amount of the received light beam. Alternatively, the photo-detector 60 or 70 may include four photodetectors PDA, PDB, PDC and PDD which are halved in the radial direction and the signal track direction of the recording medium 50. The photodetectors included in the photodetectors 60 and 70 are not limited to the present embodiment and may be variously modified if necessary.

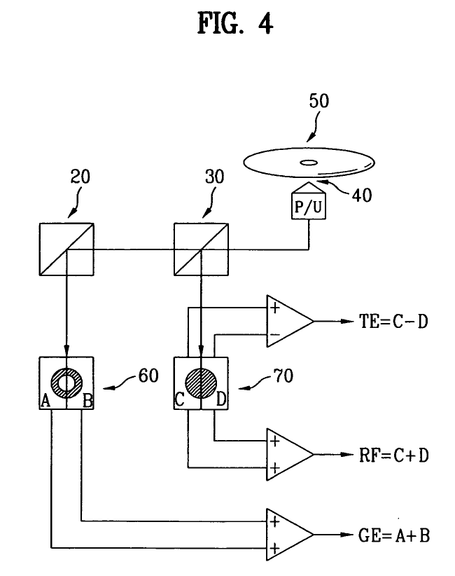

The signal generator 2 shown in FIG. 1 generates an RF signal necessary for data reproduction, a gap error signal GE and tracking error signal TE necessary for servo control, using the signal generated in the optical pickup 1. These signals will be described in detail with reference to FIG. 4.

The controller 3 receives the signal generated in the photo-detectors or the signal generator 2 and generates a control signal or a drive signal. For example, the controller 3 processes the gap error signal GE and outputs a drive signal for controlling the gap between the lens part 40 and the recording medium 50 to the gap servo drive unit 4. The controller 3 processes the tracking error signal TE and outputs a drive signal for controlling tracking to the tracking servo drive unit 5.

The controller 3 outputs the drive signal to the tracking servo drive unit 5 or the sled servo drive unit 6 such that the lens part 4 or the optical pickup 1 moves according to a distance of moving tracks, when a track seek command is input or a track needs to be sought.

At this time, the controller 3 may apply an offset corresponding to the distance of moving tracks to the gap error signal GE for controlling the gap between the lens part 40 and the recording medium 50. Accordingly, while lens part moves the tracks, the lens part 40 or the optical pickup 1 may vertically move, which will be described later.

The gap servo drive unit 4 drives an actuator (not shown) in the optical pickup 1 to vertically move the optical pickup 1 or the lens part 40 of the optical pickup. Accordingly, it is possible to uniformly maintain the gap between the lens part 40 and the recording medium 50.

The gap servo drive unit 4 may also perform a focus servo function. For example, the optical pickup 1 or the lens part 40 of the optical pickup may trace the vertical movement together with the rotation of the recording medium 50 according to a signal for focus control of the controller 3.

The tracking servo drive unit 5 drives a tracking actuator (not shown) in the optical pickup 1 to move the optical pickup 1 or the lens part 40 of the optical pickup in a radial direction such that the position of the light beam is corrected. The optical pickup 1 or the lens part 40 of the optical pickup may trace a certain track provided on the recording medium 50. The tracking servo drive unit 5 may move the optical pickup 1 or the lens part 40 of the optical pickup in the radial direction according to a track seek command.

The sled servo drive unit 6 may drive a sled motor (not shown) for moving the optical pickup 1 to move the optical pickup 1 in the radical direction according to the track seek command.

In the recording and/or playback apparatus, a host such as a personal computer (PC) may be included. The host transmits a recording and/or playback command to the microcomputer 100 via an interface, receives reproduced data from a decoder 7, and transmits data to be recorded to an encoder 8. The microcomputer 100 controls the decoder 7, the encoder and the controller 3 according to the recording and/or playback command of the host.

The interface may generally use an advanced technology attached packet interface (ATAPI) 110. The ATAPI 110 is an interface standard between an optical recording and/or playback apparatus such as a CD or DVD drive and the host such that the optical recording and/or playback apparatus transmits decoded data to the host. The ATAPI 110 converts the decoded data into a protocol in a packet form which can be processed in the host and transmits the protocol to the host.

Hereinafter, in the optical pickup 1 of the recording and/or playback apparatus according to the embodiment of the present invention, the operation of the optical system will be described based on a travel direction of the light beam emitted from the optical source 10 and the operation of the other parts will be described based on the flow of a signal.

The light beam emitted from the optical source 10 of the pickup 1 enters the first separation/combination part 20 and a part of the light beam is reflected from the first separation/combination part 20 and another part of the light beam passes through the first separation/combination part 20 to enter the second separation/combination part 30. The second separation/combination part 30 passes a vertically polarized component and reflects a horizontally polarized component in the linearly polarized light beam, and vice versa. A polarization converting plane (not shown) may be provided on the path of the light beam which passes through the second separation/combination part 30 and will be described in detail later.

The light beam which passes through the second separation/combination part 30 enters the lens part 40. The light beam which enters the objective lens of the lens part 40 forms an evanescent wave by passing through the near field lens. In particular, the light beam which enters the near field lens at a threshold angle or more totally reflects from the surface of the lens and the surface of the recording medium 50. The light beam which enters the near field lens at an angle less than the threshold angle reflects from the recording layer of the recording medium 50. The evanescent wave formed at this time reaches the recording layer of the recording medium 50 to perform recording/reproduction.

The light beam reflected from the recording medium 50 enters the second separation/combination part 30 via the lens part 40 again. At this time, as described above, the polarization converting plane (not shown) may be provided on the path of the light beam which enters the second separation/combination part 30. The polarization converting plane converts the polarization directions of the light beam which enters the recording medium 50 and the light beam which reflects from the recording medium 50. When a ¼ wavelength plate (QWP) is used as the polarization converting plane, the QWP left-circular polarizes the light beam which enters the recording medium 50 and right-circular polarizes the light beam which reversely travels. As a result, the polarization direction of the reflected light beam which passes through the QWP is converted into a direction different from that of the incident light beam, and a difference in the polarization direction between the reflected light beam and the incident light beam is 90 degrees. Therefore, only the horizontally polarized light component which passes through the second separation/combination part 30 and enters the recording medium 50 is converted into the vertically polarized light component when reflecting from the recording medium 50 and entering the second separation/combination part 30 again. The vertically polarized light component of the reflected light beam reflects from the second separation/combination part 30 and the reflected light beam enters the second photo-detector 70.

In the near field recording and/or playback apparatus according to the present invention, the numerical aperture NA of the lens part 40 is larger than 1 and thus a distortion occurs in the polarization direction when the light beam is irradiated and reflected via the lens part 40. That is, a part of the reflected light beam which enters the second separation/combination part 30 has the horizontally polarized light component by the distortion of the polarization direction and passes through the second separation/combination part 30. The passed reflected light beam enters the first separation/combination part 20. The first separation/combination part 20 passes a part of the incident light beam and reflects another part thereof. The light beam reflected from the first separation/combination part 20 enters the first photo-detector 60.

The first photo-detector 60 and the second photodetector 70 output the electric signals corresponding to the amounts of the received light beams, respectively. The signal generator 2 generates the gap error signal GE, the tracking error signal TE or the RF signal using the electric signals output from the photo-detectors 60 and 70.

The signal generated at the signal generator 2 will be described in detail with reference to FIG. 4. The first photo-detector 60 and the second photo-detector 70, for example, include two photodetectors, respectively, as shown in FIG. 4.

The two photodetectors included in the first photodetector 60 output electric signals A and B corresponding to the amount of the received light beam, respectively. The two photodetectors included in the second photodetector 70 output electric signals C and D corresponding to the amount of the light beam, respectively.

The signal generator 2 may generate the gap error signal GE for controlling the gap between the lens part and the recording medium 50 using the signals A and B output from the first photo-detector 60. The gap error signal GE may be generated by adding the signals output from the photodetectors included in the first photo-detector 60. The generated gap error signal GE is expressed by Equation 1.

GE=A+B Equation 1

Since the gap error signal GE corresponds to the sum of the electric signals corresponding to the amount of the light beam, the gap error signal GE is proportional to the amount of the reflected light beam which is received by the first photo-detector 60.

The signal generator 2 may generate the RF signal for performing recording/reproduction or the tracking error signal TE for controlling the tracking, using the signals C and D output from the second photo-detector 70. The RF signal may be generated by adding the signals output from the photodetectors included in the second photo-detector 70, as expressed by RF=C+D. The tracking error signal TE may be generated by a difference between the signals output from the photodetectors, as expressed by TE=C−D.

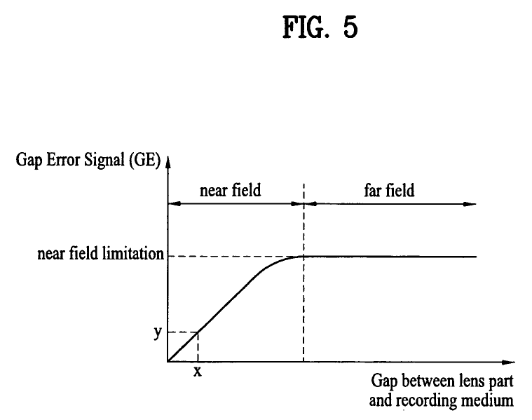

As shown in FIG. 5, the gap error signal GE is proportional to the gap G between the lens part 4 and the recording medium 50 in the near field and is uniform in the far field, which will now be described in detail. When the light beam which enters at the threshold angle or more totally reflects from the surface of the recording medium 50, the gap G between the lens part 40 and the recording medium 50 is larger than or equal to the size of the near field, that is, is larger than or equal to λ/4 which is a near field limitation (that is, a boundary between the near field and the far field). In contrast, when the gap G between the lens part 40 and the recording medium 50 is smaller than λ/4, a part of the light beam which enters at the threshold angle or more passes through the recording medium 50 to reach the recording layer, even when the lens part 40 and the recoding medium 50 do not contact each other. At this time, as the gap between the lens part 40 and the recording medium 50 is small, the amount of the light beam which passes through the recording medium 50 increases and the amount of the light beam which totally reflects from the surface of the recording medium 50 decreases. As the gap between the lens part 40 and the recording medium 50 is large, the amount of the light beam which passes through the recording medium 50 decreases and the amount of the light beam which totally reflects from the surface of the recording medium 50 increases. Therefore, the strength of the light beam reflected from the surface of the recording medium is proportional to the gap G between the lens part 40 and the recording medium 50 in the near field and becomes uniform when the gap G is larger than or equal to λ/4 which is the near field limitation (that is, the boundary between the near field and the far field). The strength of the gap error signals GE proportional to the strength of the reflected light beam is also proportional to the gap G in the near field and has a constant value (maximum value) outside the near field. Based on such a principle, the gap error signal GE is uniform when the gap G between the lens part 40 and the recording medium 50 is maintained to be uniform in the near field. That is, it is possible to control the gap G between the lens part 40 and the recording medium 50 to be uniform by feedback-controlling the gap error signal GE to have a constant value.

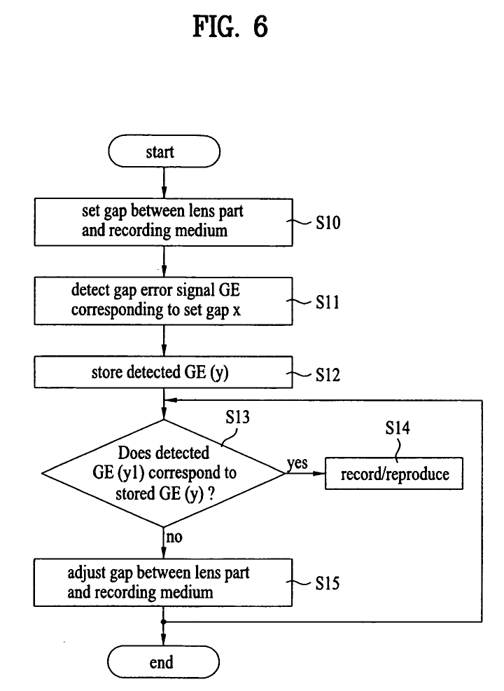

A method of controlling the gap between the lens part 40 and the recording medium 50 to be uniform using the gap error signal GE will be described in detail with reference to FIGS. 5 and 6.

A gap x between the lens part 40 and the recording medium 50 suitable for detecting the signal of the reflected light beam is set (S10). The gap error signal GE (y) detected at the set gap x is detected (S11). The detected gap error signal GE (y) is stored (S12). Here, y may be set to be larger than 10 to 20% of the near field limitation (λ/4) such that the probability of collision between the lens part 40 and the recording medium 50 does not increase. In addition, y may be set to be smaller than 80 to 90% of the near field limitation (λ/4) such that the probability that the lens part 40 becomes distant from the recording medium 50 and moves out of the near field does not increase. This step may be performed before recording and/or playback data on/from the recording medium 50.

When the data is recorded and/or playback on/from the recording medium 50 which rotates, the light beam irradiated onto the track of the recording medium 50 is reflected to enter the first photo-detector 60. The signal generator 2 generates the gap error signal GE using the signal output from the first photo-detector 60. At this time, it is determined whether the detected gap error signal GE (y1) corresponds to the stored gap error signal GE (y) (S13). When the detected gap error signal GE (y1) corresponds to the stored gap error signal GE (y), the set gap is maintained and thus the recording and/or playback process continues to be performed at that state (S14). In contrast, when the detected gap error signal GE (y1) does not correspond to the stored gap error signal GE (y), since the gap is changed, the gap between the lens part 40 and the recording medium 50 can be adjusted by driving the lens part 40. The gap between the lens part 40 and the recording medium 50 can be maintained to be uniform by feedback-controlling the lens part 40 using the gap error signal GE detected upon recording and/or playback process.

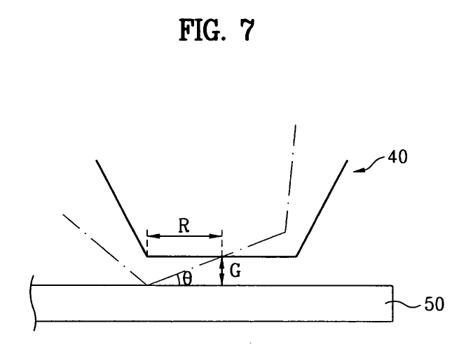

Hereinafter, a method of moving tracks and a recording and/or playback method when the track needs to be sought or the track seek command is input will be described in detail with reference to FIGS. 7 to 10.

FIG. 7 is a view showing a maximum angle allowing a tilt when the gap G between the near field lens and the recording medium is uniform. When enlarging the distal end of the lens part 40 which is close to the recording medium 50, the lens part 40 is spaced apart from the recording medium 50 by a predetermined gap G. At this time, a tilt limitation angle θ which allows the lens part 40 to collide with the recording medium 50 due to disturbance such as the tilt of the lens part 40 and the axial vibration of the recording medium 50 is determined by Equation 2.

$$θ = {tan}^{- 1} ( \frac{G}{R} ) \qquad Equation 2$$

Where, G denotes the gap between the lens part 40 and the recording medium 50 and R denotes half of the diameter of the bottom surface of the lens part 40 which faces the recording medium 50. For example, when the gap G is 20 nm and the diameter of the lens part 40 is 40 μm, the tilt limitation angle is 0.057°. That is, since the tilt limitation angle is very small, the probability that the near field lens collides with the recording medium 50 by a fine tilt is high while lens part moves the tracks.

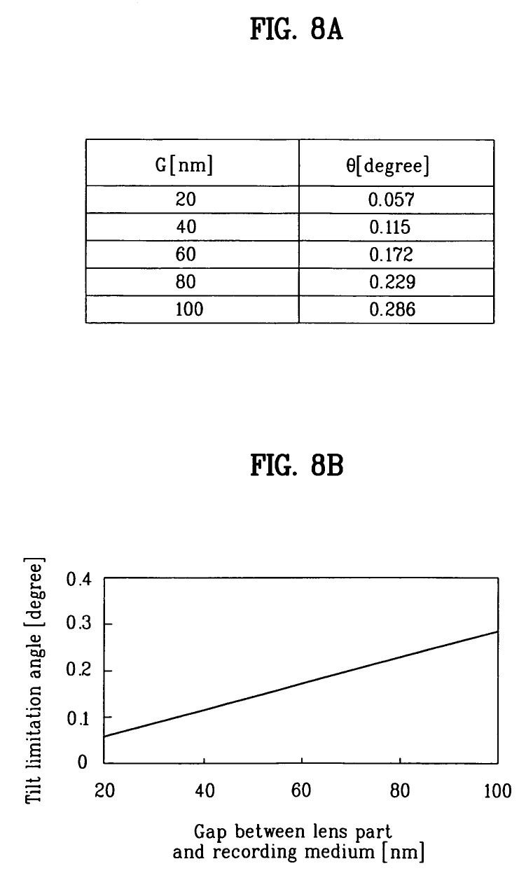

FIGS. 8a and 8b show the tilt limitation angle according to a variation in the gap G between the lens part 40 and the recording medium 50. As shown, the tilt limitation angle linearly increases proportional to the gap G. Therefore, if the tilt limitation angle increases by vertically driving the lens part 40 relative to the recording medium 50 while lens part moves the tracks, it is possible to prevent the lens part 40 from colliding with the recording medium 50 while lens part moves the tracks.

### First Embodiment of Method of Moving Tracks

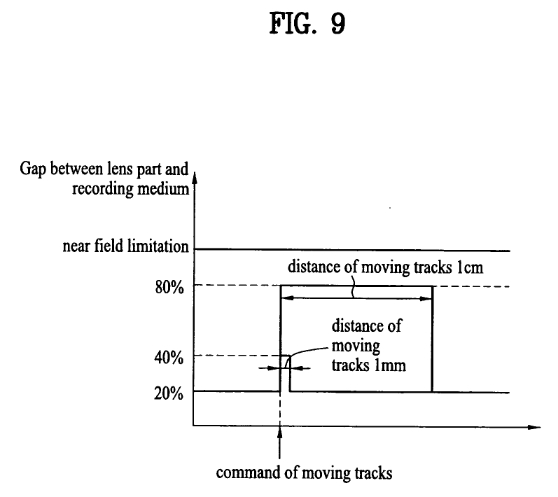

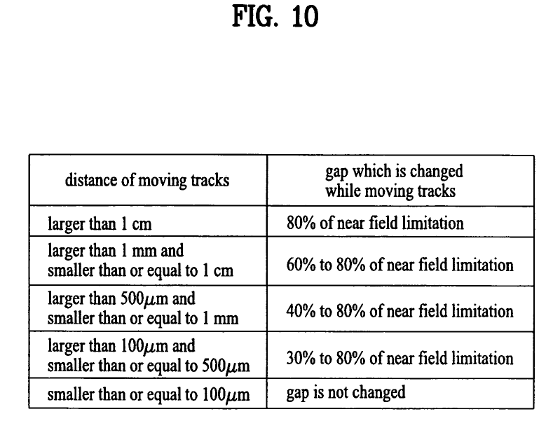

A method of moving tracks according to a first embodiment of the present invention will be described in detail with reference to FIGS. 9 and 10. The method of moving tracks according to the present invention includes a track seeking method (also referred to as “rough seek”) for moving the optical pickup 1 by a coarse motor such as the sled servo drive unit 6 and a method (also referred to as “fine seek”) for driving the lens part 40 by a fine drive unit in the optical pickup 1, such as an actuator (not shown). The optical pickup 1 or the lens part 40 may vertically move when the optical pickup 1 or the lens part 40 moves in the radial direction.

In the present specification, a case where the gap servo is performed at the gap G corresponding to 20% of the near field limitation in which a signal is easiest observed in the near field limitation (λ/4 may be the near field limitation, as described above) will be described. As shown in FIG. 9, when the gap G corresponding to 20% of the near field limitation is controlled to be maintained, the gap servo is performed to control the gap between the lens part 40 and the recording medium 50 to be uniform, as described in FIG. 6.

At this time, when the track seek command is input or the track needs to be sought, the tilt limitation angle may increase by increasing the gap between the lens part 40 and the recording medium 50 in a range smaller than or equal to 80% of the near field limitation. Here, 80% is an experimentally determined value and becomes a range for preventing the gap between the lens part 40 and the recording medium 50 from becoming larger than the near field limitation due to the tilt or the axial vibration. It is possible to minimize the probability that the lens part 40 collides with the recording medium 50 while lens part moves the tracks.

As shown, when the distance of moving tracks is as large as 1 cm, the gap may increase to about 80%, and, when the distance of moving tracks is as small as 1 mm, the gap may increase to about 40%. That is, the gap can be stepwise adjusted according to the distance of moving tracks. As described above, a method of adjusting the gap according to the distance of moving tracks will be described in detail with reference to FIG. 10.

That is, when the distance of moving tracks exceeds 1 cm, it is possible to increase the gap between the lens part 40 and the recording medium to 50 to 80% of the near field limitation while lens part moves the tracks. Accordingly, it is possible to minimize the probability of collision when the distance of moving tracks is large.

When the distance of moving tracks is larger than 1 mm and smaller than or equal to 1 cm, the gap between the lens part 40 and the recording medium 50 increases in a range of 60 to 80% of the near field limitation while lens part moves the tracks.

When the distance of moving tracks is larger than 1 mm and smaller than or equal to 1 cm, the gap between the lens part 40 and the recording medium 50 increases in a range of 60 to 80% of the near field limitation while lens part moves the tracks.

When the distance of moving tracks is larger than 500 μm and smaller than or equal to 1 mm, the gap between the lens part 40 and the recording medium 50 increases in a range of 40 to 80% of the near field limitation while lens part moves the tracks.

When the distance of moving tracks is larger than 100 μm and smaller than or equal to 500 μm, the gap between the lens part 40 and the recording medium 50 increases in a range of 30 to 80% of the near field limitation while lens part moves the tracks.

When the distance of moving tracks is smaller than or equal to 100 μm, the track is sought without changing the gap between the lens part 40 and the recording medium 50.

The percentages of the near field limitation described herein indicate suitable reference values and may be smaller than the reference values. The range of the distance of moving tracks is exemplarily described in the embodiment, is not limited to the above-described ranges and may be changed/

### Second Embodiment of Method of Moving Tracks

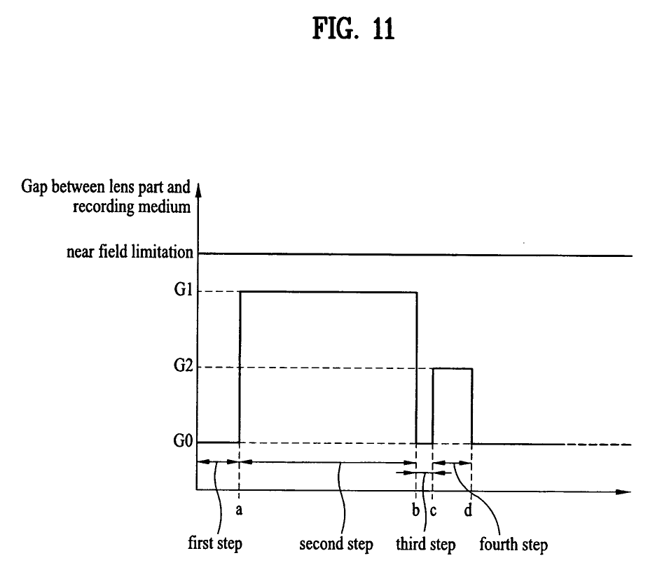

A method of moving tracks according to a second embodiment of the present invention will be described in detail with reference to FIG. 11. In the present embodiment, only a portion different from the first embodiment will be described.

FIG. 11 shows a variation in the gap between the lens part 40 and the recording medium 50 in a recording and/or playback method according to an embodiment of the present invention. As shown, in the recording and/or playback method according to the present invention, the method of moving tracks may include four steps. Hereinafter, the steps will be sequentially described in detail.

A first step is a recording and/or playback step in a recording and/or playback apparatus. This step indicates the step of playback data from the inserted recording medium 50 or recording data on the recording medium 50, that is, a driving state before a track seek command is input. In the recording and/or playback step, the lens part 40 and the recording medium 50 maintain a constant gap. At this time, the gap is called a zero level G0.

The zero level G0 is decided as follows. First, the lens part (more particularly, near field lens) is preferably spaced apart from the recording medium by a gap smaller than ¼ of the light wavelength λ to be located in the near field. The zero level G0 is decided in consideration of the disturbance and recording density. Although the lens part is located in the near field, it is difficult to determine that the lens part is stably located in the near field when the lens part is close to the near field limitation (in the vicinity of ¼ of the light wavelength). When the lens part is located in the near field but is too close to the recording medium 50, the disturbance such as the axial vibration of the recording medium 50 is apt to occur and the light beam spot increases and thus the recording density is reduced. Therefore, the zero level G0 is decided by the above-described factors and is in a range of 20 to 30 nm.

The recording and/or playback apparatus according to the present invention can perform the servo function in real time so as to maintain the zero level G0 and the servo function will now be described in detail.
By a servo controller of the optical pickup 1, the light beam focused by the lens part 40 is laid on a track of the recording medium 50. The light beam reflected from the recording medium 50 are focused by the lens part 40 and input to the photo-detector 60. Then, the gap error signal GE corresponding to the amount of the reflected light beam is generated. The gap error signal GE is input to the controller 3 to generate the drive signal for controlling the gap G and the drive signal is output to the gap servo drive unit 4. The gap servo drive unit 4 drives a gap actuator (not shown) to adjust the gap between the lens part 40 of the optical pickup 1 and the recording medium 50 such that the zero level G0 is controlled to be maintained in real time. That is, at the zero level G0, the data can be recorded and/or playback and the servo is performed.

In the optical recording and/or playback apparatus, when the track seek command is input in a state that the zero level G0 is maintained, the track is sought by second to fourth steps. That is, the second to fourth steps correspond to the track seek step. The track seek operation indicates that the optical pickup moves to a target track in correspondence with a seek command from a first track to a second track of the recording medium 50 when recording and/or playback the data on/from the recording medium 50. That is, the lens part 40 of the optical pickup 1 moves in the radial direction to accurately position the laser light beam on the target track of the recording medium 50.

The method of moving tracks according to the present invention is performed by two steps including a rough seek step (second step) of moving the optical pickup 1 by the coarse motor to jump the track and a fine seek step (fourth step) of jumping the track using the actuator (not shown) in the optical pickup 1. At this time, the lens part 40 is vertically driven, that is, vertically moved. When the rough seek step is switched to the fine seek step, a step (third step) of moving the lens part to the zero level G0 and checking the position information is further included. At this time, the lens part 40 is vertically driven to increase the tilt limitation angle while lens part moves the tracks.

The track seek operation, that is, the second to fourth steps, according to the present invention will be described in detail with reference to FIG. 11.

In the track seek operation, the number of tracks in a range from a current track to a target track is calculated and, when the number of tracks to be jumped is several hundreds to several thousands, the sled servo drive unit 6 moves the optical pickup 1 to the vicinity of the target track using the sled motor, that is, the rough seek step is performed. When a rough seek command is input (a), the lens part 40 of the optical pickup 1 is vertically driven. That is, in the rough seek step, the lens part 40 is vertically moved such that the gap G between the recording medium 50 and the lens part 40 becomes larger than the zero level G0. The tilt limitation angle increases by increasing the gap. At this time, the gap between the lens part 40 and the recording medium 50 is called a first level G1.

It is preferable that the first level G1 is set to be as large as possible so as to maximize the tilt limitation angle. That is, the gap between the lens part and the recording medium 50, that is, the first level G1, is larger than the zero level G0 in which the servo is performed. Therefore, at the first level G1, the data may not be recorded and/or playback on/from the recording medium or the track may not be counted. The first level G1 is preferably at most λ/4 such that the lens part is prevented from moving out of the near field.

In the third step, when the lens part 40 moves to a position corresponding to the rough seek command (b), the lens part 40 is vertically driven. That is, the lens part 40 vertically moves to the zero level G0 and the track information of the current position is collected.

When the position information of the moved track is collected, a difference between the current track and the target track, that is, an error, is calculated. When the error is not in a certain range which is a start reference of the fine seek step, the rough seek step may be performed again (not shown). In contrast, when the error is in the certain range, a fine seek command is input (c). At this time, the certain range which is the start reference of the fine seek step is set to one thousand to several hundreds of tracks and may be set to one thousand tracks.

In the fourth step, when the fine seek command is input, the lens part 40 is vertically driven. At this time, the gap between the vertically driven lens part 40 and the recording medium 50 is called a second level G2. The second level G2 may be larger than the zero level G0 and smaller than the first level G1. That is, the tilt limitation angle is larger than that of the zero level G0, but is smaller than that of the rough seek step, since the fine seek step is performed using the actuator.

At this time, in the fine seek step, the lens part 40 located at the second level G2 moves to the target track by driving the actuator while the track is counted. That is, in the second level G2, the recording/reproduction of the data is not performed and the track can be counted.

When the lens part 40 moves to the target track, the lens part 40 is vertically driven to the zero level G0. The lens part 40 which is located on the target track maintains the zero level G0 and the recording and/or playback step is performed again.

By repeating the above-described operations, the target track can be accurately sought. In the rough seek step and the fine seek step, the lens part 40 is vertically driven to prevent the lens part 40 from colliding with the recording medium 50 and to allow the recording/reproduction.

In the present embodiment, the vertical drive may be performed using a physical method or a signaling method. As the signaling method, an offset corresponding to the variation in the gap is applied to the gap error signal GE to adjust the gap. When reaching the target track, an opposite offset is applied to the gap error signal GE such that the gap between the lens part 40 and the recording medium 50 when the servo is first performed is maintained. In the present specification, for convenience of description, although the offset of the gap error signal GE is changed, the present invention is not limited to the case where the gap error signal GE is used. In addition to the method of applying the offset to the signal, a method and apparatus for driving the lens part 40 or the optical pickup 1 so as to change the gap between the lens part 40 and the recording medium 50 according to the distance of moving tracks while lens part moves the tracks may be included.

### Third Embodiment of Method of Moving Tracks

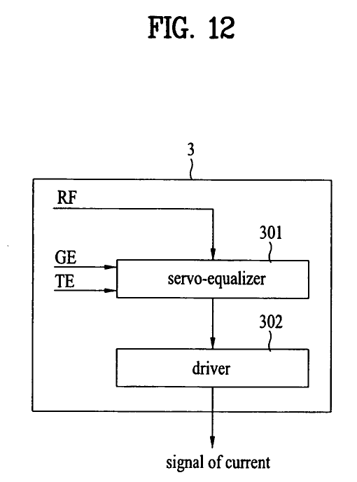

A method of moving tracks according to a third embodiment of the present invention will be described in detail with reference to FIGS. 12 to 14. In the present embodiment, only a portion different from the second embodiment will be described.

Prior to the description of the method, a recording and/or playback apparatus which can be used in the present embodiment and more particular the structure of a controller 3 will be-described in detail. In the recording and/or playback apparatus shown in FIG. 1, the controller 3 may be configured as shown in FIG. 12.

FIG. 12 is a view showing in detail an internal structure of the controller 3 according to an embodiment of the present invention. A servo-equalizer 301 receives a gap error signal GE or a tracking error signal TE from the signal generator 2 of FIG. 1, and adjusts a compensation gain to compensate for an error according to feed-back control. Similar to the method of the second embodiment, the gap between the lens part 40 and the recording medium 50 changes depending on the location of the lens part 40(For example, the location at a 0^{th} level G0 or a first level G1 of lens part). Therefore, it is possible to efficiently compensate the error by changing the compensation gain of the error signal according to the gap. That is, when the lens part 40 is close to the recording medium 50, a gap error margin is small. Thus, the compensation gain decreases. In contrast, when the lens part 40 is far from the recording medium 50, the gap error margin is large. Thus, the compensation gain increases and the error signal is feed back controlled to compensate the error, thereby efficiently driving the system. The servo-equalizer 301 changes the gain depending on whether the lens part 40 is located at the 0^{th} level G0 or the first level G1 to drive the system. A driver 302 converts a voltage signal corresponding to a value obtained by multiplying the error signal and the compensation gain received from the servo-equalizer 301 into a current signal and transmits the current signal to the gap servo drive unit 4, the tracking servo drive unit 5, or the sled servo drive unit 6. The gap servo drive unit 4, the tracking servo drive unit 5, or the sled servo drive unit 6 drives the sled motor 108 or the actuator (not shown) of the optical pickup 1.

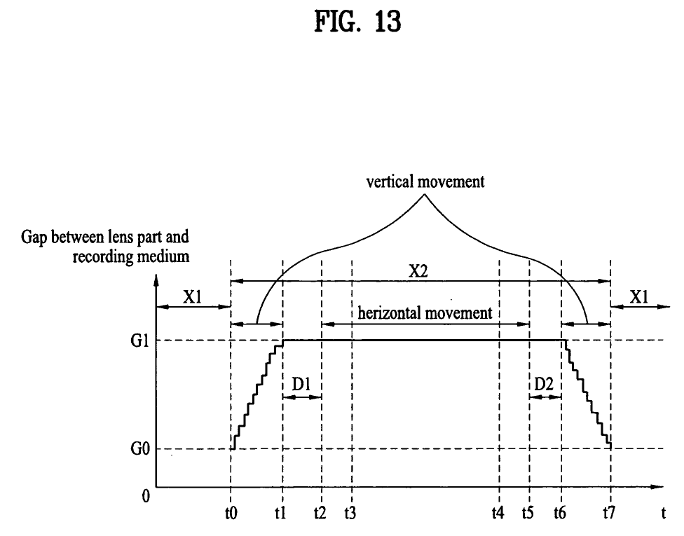

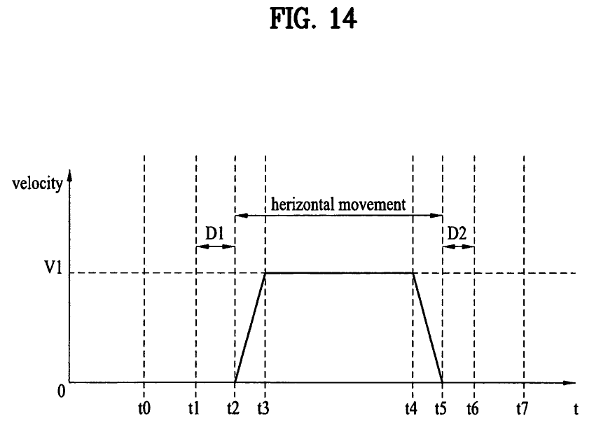

FIGS. 13 and 14 show the case where the lens part 40 or the optical pickup 1 moves stepwise in the track seek method according to the embodiment of the present invention. This movement is applicable to the first embodiment, the second embodiments or other method of moving tracks. For convenience of description, the second embodiment will be described.

FIG. 13 shows the variation in the gap between the lens part 40 and the recording medium 50 in the recording and/or playback process. Similar to the above-described embodiment, for convenience of description, for example, the case where the lens part 40 or the optical pickup 1 moves from a first track to a second track will be described. In the present embodiment, the description of the same portion as the second embodiment will be omitted and only a portion different from the second embodiment will be described.

In FIG. 13, a time period 0 to t0 corresponds to a first step described in FIG. 11 that is the recording and/or playback step or a step of checking the position of a current track. A time period t1 to t6 corresponds to the second step of FIG. 11, and a time period after a time point t7 corresponds to the step after the third step. The time periods will be described in detail.

When a track seek command is received at a time point t0, the gap between the lens part 40 and the recording medium 50 is changed stepwise from the 0^{th} level G0 to the first level G1 by the gap servo drive unit 4. In the present embodiment, the lens part 40 does not move at a time, that is moves stepwise by the gap servo drive unit 4 from the 0^{th} level G0 to the first level G1, for a rough seek, such that the influence due to disturbance or a servo error can be minimized. The unit of the vertical movement of the lens part 40 by the gap servo drive unit 4 may vary according to the embodiment. The time periods t0 to t1 and t6 to t7 for vertical movement may be equally divided into about 100 sub-time periods. At the initial portions of the time periods t0 to t1 and t6 to t7, the lens part 40 moves up or down by a small distance. The movement distance gradually increases. As the lens part approaches a target level, the lens part may move up or down while decreasing the movement distance.

When the lens part 40 reaches the first level G1 at a time point t1, the lens part moves horizontally after a delay time period D1 from t1 to t2 elapses. The delay time period D1 may be set to about 1 to 10 ms. When the lens part moves horizontally after the time period elapses, it is possible to minimize the influence due to a disturbance or servo error, compared with the case where the lens part moves horizontally immediately after the lens part moves vertically to the first level G1.

In a time period t2 to t5, the lens part 40 moves horizontally to the second track by driving the sled servo drive unit 6 or the actuator (not shown). The lens part 40 moves vertically after a delay time period D2 from t5 to t6 elapses from the time point when the lens part reaches the second track. At this time, the delay time period D2 may be set to about 1 to 10 ms. In the time period t6 to t7, the lens part 40 vertically moves stepwise to the 0^{th} level G0, similar to the time period t0 to t1. At this time, the direction of the time period t6 to t7 is opposite to that of the time point from t0 to t1 and thus the lens part moves to the 0^{th} level G0.

When the lens part 40 does not accurately reach the second track, a fine seek operation may be performed after the time point t7 as shown in FIG. 11. When the lens part accurately reaches the second track, the recording and/or playback operation is performed.

The controller 3 sets the gain of the servo-equalizer 301 to a first compensation gain Xl when the lens part 40 is at the 0^{th} level (in the time period 0 to t0 and the time period after the time point t7) and sets the gain of the servo-equalizer 301 to a second compensation gain G2 larger than the first gain X1 when the lens part 40 is at the first level, thereby compensating the error. According to the embodiment, the gain may be changed before the time periods t0 to t1 and t6 to t7 or the gain may be changed after the time period t0 to t1 and t6 to t7. As an embodiment, in FIG. 13, the compensation gain is changed from X1 to X2 at the time point t0 before the lens part 40 moves vertically to the first level G1, and the compensation gain is changed from X2 to X1 at the time point t7 after the lens part 40 moves vertically to the 0^{th} level G0.

FIG. 14 shows the efficient horizontal movement velocity of the lens part 40 according to the present embodiment. That is, a disturbance or servo error is minimized by adequately adjusting the horizontal movement velocity of the lens part 40. The time axis of FIG. 14 corresponds to that of FIG. 13. The detailed description is as follows:

When the lens part 40 moves horizontally, the lens part 40 does not move at a uniform velocity from the first track to the second track, that is the movement velocity of the lens part 40 varies over time. For example, the lens part 40 accelerates at the initial time period t2 to t3, moves at a uniform velocity when the velocity of the lens part reaches a velocity v1 (the time period t3 to t4), and decelerates and stops at a target point when the lens part approaches the target point (the time period t4 to t5).

The movement velocity of the lens part shown in FIG. 14 may vary depending on a track seek method. Here, the actuator (not shown) for horizontally moving the lens part 40 or the sled servo drive unit 6 for horizontally moving the optical pickup 1 has the above-described velocity variation profile.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

### INDUSTRIAL APPLICABILITY

According to the present invention, it is possible to minimize or prevent the collision between the lens part and the recording medium and to efficiently seek the track to perform recording/reproduction when recording and/or playback data on/from the recording medium.

According to the present invention, it is possible to provide a method of moving tracks capable of minimizing an error due to collision while lens part moves the tracks and a recording and/or playback method and apparatus using the same.

1. A method of moving tracks comprising:
changing a gap between a lens and a recording medium in correspondence with a distance of the moving tracks while the lens moves from one track to another.

2. The method according to claim 1, wherein the gap between the lens and the recording medium is stepwise changed according to the distance of moving tracks.

3. The method according to claim 1, wherein the gap between the lens and the recording medium is increased to increase a tilt limitation angle as the distance of moving tracks is large.

4. The method according to claim 1, further comprising returning the gap to an original state and determining whether a reached track is a target track.

5. The method according to claim 4, further comprising changing the gap between the lens and the recording medium according to the distance of moving tracks to move the lens or the optical pickup to the target track, if the reached track is not the target track.

6. A method of moving tracks comprising:
changing a gap between a lens and a recording medium to a predetermined level and horizontally moving the lens from a track to another track,
wherein the gap between a lens and a recording medium is changed stepwise.

7. The method according to claim 6, wherein the lens moves horizontally after a predetermined time delay followed the changing of gap between the lens and the recording medium.

8. The method according to claim 6, wherein a horizontal movement velocity of the lens varies over time when the lens moves horizontally.

9. The method according to claim 8, wherein the horizontal movement velocity gradually increases in an initial time period and gradually decreases a last time period.

10. The method according to claim 9, wherein the horizontal movement velocity is of a uniform velocity in a time period between the initial time period and the last time period.

11. A recording and/or playback method comprising: controlling a gap between a lens and a recording medium to be uniform, using a control signal,
wherein the gap is changed by applying an offset corresponding to a distance of moving tracks to the control signal while lens part moves the tracks.

12. The method according to claim 11, wherein the offset is stepwise changed in correspondence with the distance of moving tracks.

13. The method according to claim 12, wherein the level of the offset is proportional to the distance of moving tracks.

14. The method according to claim 11, wherein the gap between the lens and the recording medium is controlled to be in a range of 20% to 80% of a near field limitation.

15. A method of recording and/or playback data on/from a recording medium, the method comprising:
(a) changing a gap between a lens and the recording medium to a first level and moving the lens to a target track while moving tracks; and
(b) changing the gap to a second level and minutely moving the lens or the optical pickup from a reached track to the target track while a track is counted.

16. The method according to claim 15, further comprising (c) changing the gap to an original state at the reached track and checking the position of a current track.

17. The method according to claim 16,
wherein the step (c) is performed after the step (a) and/or (b).

18. The method according to claim 15, wherein the first level is larger than the second level.

19. The method according to claim 16, wherein the step (a) is repeatedly performed when the position of the current track which is checked in the step (c) is spaced apart from the target track by at least a predetermined distance.

20. The method according to claim 19, wherein the step (a) is repeatedly performed when a difference between the current track and the target track is at least 1000 tracks.

21. The method according to claim 15, wherein the gap between the lens and the recording medium is controlled to be in a range of 20% to 80% of a near field limitation.

22. The method according to claim 15, wherein, in the step (a), the gap between the lens and the recording medium is changed stepwise.

23. The method according to claim 15, wherein the lens moves horizontally after a predetermined time delay followed the changing to the gap between the lens and the recording medium.

24. The method according to claim 15, wherein the horizontal movement velocity of the lens varies over time when the lens or the optical pickup moves to another track.

25. The method according to claim 8, wherein the horizontal movement velocity gradually increases in an initial time period and gradually decreases a last time period.

26. A recording and/or playback apparatus comprising:
a pickup including a lens and irradiating a light beam emitted from a optical source onto a recording medium;
a gap servo controlling a gap between the lens and the recording medium using a gap control signal generated by the light beam reflected from the recording medium; and
a controller applying an offset corresponding to a distance of moving tracks to the gap control signal and changing the gap while lens part moves the tracks.

27. The apparatus according to claim 26, wherein the controller stepwise applies the offset which is changed according to the distance of moving tracks and changes the gap according to the distance of moving tracks.

28. The apparatus according to claim 27, wherein the level of the offset is proportional to the distance of moving tracks.

29. The apparatus according to claim 26, wherein the strength of the gap control signal is proportional to the gap between the lens and the recording medium.

30. The apparatus according to claim 26, wherein the gap servo feedback-controls the gap control signal to be maintained at a predetermined value and changes the gap between the lens and the recording medium according to the offset included in the gap control signal.

31. The apparatus according to claim 30, wherein the gap between the lens and the recording medium does not exceed 80% of a near field limitation.

32. The apparatus according to claim 26, further comprising a lens drive unit or a pickup drive unit changing the gap between the lens and the recording medium.

33. The apparatus according to claim 26, wherein the controller controls the gap between the lens and the recording medium by increasing or decreasing a compensation gain of an error signal.
